(19) United States
(12) Patent Application Publication
(10) Pub. No.: US 2009/0265578 A1
(43) Pub. Date: Oct. 22, 2009

(54) Full Stripe Processing for a Redundant Array of Disk Drives

(76) Inventors: Doug Baloun, San Mateo, CA (US); Richard Biskup, Sunnyvale, CA (US)

Correspondence Address: LAW OFFICE OF GERALD MALISZEWSKI, P.O. BOX 270829, SAN DIEGO, CA, 92198-2829, US

(21) Appl. No.: 12/493,367

(22) Filed: Jun. 29, 2009

Related U.S. Application Data
(63) Continuation of application No. 12/029,688, filed on Feb. 12, 2008.

(51) Int. Cl. G06F 11/16; G06F 11/00; G06F 12/00

(52) U.S. Cl. 714/6; 711/114; 711/E12.001; 714/E11.062

(57) ABSTRACT

A system and method are provided for automating full stripe operations in a redundant data storage array. In a redundant storage device controller, a parity product is accumulated that is associated with an information stripe. The parity product is stored in controller memory in a single write operation. A stored parity product is then written in a storage device. The parity product may be accumulated in a RAID controller, stored in a RAID controller memory, and written in a RAID. For example, the controller may receive n data stripelets for storage. The parity product is accumulated by creating m parity stripelets, and the m parity stripelets are written into the controller memory in a single write operation. Alternately, the controller may receive (n+m−x) stripelets from a RAID with (n+m) drives, recover x stripelets, and write x stripelets into controller memory in a single write operation.

### RELATED APPLICATIONS

This application is a Continuation of a pending application entitled, AUTOMATED FULL STRIPE OPERATIONS IN A REDUNDANT ARRAY OF DISK DRIVES, invented by Baloun et al., Ser. No. 12/029,688, filed Feb. 12, 2008, attorney docket no. applied_{—}188, which is incorporated herein by reference.

### BACKGROUND OF THE INVENTION

1. Field of the Invention

This invention generally relates to data storage and, more particularly, to a system and method for automating full stripe operations in a redundant array of disk drives (RAID).

2. Description of the Related Art

FIGS. 1A and 1B are diagrams depicting a RAID 5 system (prior art). RAID 5 and RAID 6 are well known as systems for the redundant array of independent disks. Instead of distributing data “vertically” (from lowest sector to highest) on single disks, RAID 5 distributes data in two dimensions. First, “horizontally” in a row across n number of disks, then “vertically” as rows are repeated. A row consists of equal “chunks” of data on each disk and is referred to as a “stripe”. Each chunk of data, or each disk's portion of the stripe, is referred to as a stripelet.

For RAID 5, one of the stripelets is designated as a parity stripelet. This stripelet consists of the XOR of all the other stripelets in the stripe. The operation for XOR'ing the data for a parity stripelet is referred to as P-calculation. The purpose of the parity is to provide for a level of redundancy. Since the RAID is now depicting a virtual disk consisting of multiple physical disks, there is a higher probability of one the individual physical disks failing. If one of the stripelets cannot be read due to an individual disk error or failure, the data for that stripelet can be reassembled by XOR'ing all the other stripelets in the stripe.

The RAID 5 depicted consists of n drives. In this example, n=5. The virtual disk capacity of the system is (n−1). The data block size is equal to the sector size of an individual drive. Each stripelet consists of x data blocks. In the example shown, x=4. The stripe size is (n−1)x. For example, a virtual drive may include 2 terabytes (TB), a drive may include 500 megabytes (MB), a sector may be 512 bytes, a stripelet may be 2 kilobytes (KB), and a stripe may be 8 KB.

FIGS. 2A and 2B are a depiction of a RAID 6 system (prior art). The redundancy of RAID 5 can accommodate one failure within a stripe. RAID 6, in addition to the “P-stripelet”, allocates one or more “Q-stripelets” to accommodate two or more failures. The operation for calculating Q data involves Galois arithmetic applied to the contents of the other stripelets in the stripe. With n number of drives, the virtual disk capacity of the system is (n−2). While the stripelet size remains equal to x data blocks, the stripe size is equal to (n−2)x. For example, a virtual drive may include 1.5 TB, a dive may include 500 MB, a sector may be 512 bytes, a stripelet may be 2 KB, and a stripe may be 6 KB.

One benefit of RAID 5 and 6, other than the increased fault resiliency, is better performance when reading from the virtual disk. When multiple read commands are queued for the RAID'ed disks, the operations can be performed in parallel, which can result in a significant increase in performance compared to similar operations to a single disk. If, however, there is a failure reading the requested data, then all the remaining data of the stripe needs to be read, to calculate the requested data.

For operations that write data to the RAID'ed disks, however, performance can be adversely affected due to the P and Q calculations necessary to maintain redundant information per stripe of data. In RAID 5, for every write to a stripelet, the previously written data to that stripelet needs to be XOR'ed with the P-stripelet, effectively removing the redundant information of the “old” data that is to be overwritten. The resulting calculation is then XOR'ed with the new data, and both the new data and the new P-calculation are written to their respective disks in the stripe. Therefore, a RAID 5 write operation may require two additional reads and one additional write, as compared to a single disk write operation. For RAID 6, there is an additional read and write operation for every Q-stripelet.

FIGS. 3A and 3B are a diagram depicting a sequence of events in a RAID 5 write operation (prior art). In Step 1 new data is fetched into memory. In Step 2 old data is read from the data blocks (stripelet (2, 1)). In Step 3 old parity is read from the parity blocks (stripelet (2, 2)). In Step 4 an XOR operation is performed to remove the old data from parity. In Step 5 the parity is updated with the new data. In Step 6 the new data is written into the data blocks of stripelet (2, 1). In Step 7, the new parity is written into the parity blocks of stripelet (2, 2). Thus, every stripelet update involves 2 disk reads, 2 disk writes, 6 memory reads, and 5 memory writes.

FIGS. 4A and 4B are diagrams depicting a sequence of events in a RAID 6 write operation (prior art). In Step 1 new data is fetched into memory. In Step 2 old data is read from the data blocks (stripelet (1, 1)). In Step 3 old parity P is read from the parity P blocks (stripelet (1, 2)). In Step 4 old parity Q is read from the parity Q blocks (stripelet (1, 3)). In Step 5 an XOR operation removes the old data from parity P. In Step 6 a Galois operation removes the old data from parity Q. In Step 7 the parity P is updated with the new data. In Step 8 the parity Q is updated with the new data. In Step 9 the new data is written into the data blocks of stripelet (1, 1). In Step 10 the new parity P is written into the parity P blocks of stripelet (1, 2). In Step 11 the new parity Q is written into the parity Q blocks of stripelet (1, 3). Thus, every stripelet update involves 3 disk reads, 3 disk writes, 11 memory reads, and 8 memory writes.

If most of the write operations are sequential in nature, the write performance penalty can be lessened significantly by performing “full stripe write” operations. This method entails caching write data into an intermediate buffer, as it normally would, but instead of reading the previously written data and parity stripelets, the controller continues to cache subsequent commands until it has either cached enough data for an entire stripe, or a timeout has occurred. If the timeout occurs, the controller continues the write as described above. However, if the entire stripe is able to be cached, the controller can calculate the P and Q stripelets without the need of reading previously written data and parity.

Although, full stripe writes increase performance by reducing the number of disk accesses, the performance is gated by certain bandwidth limitations of the processor and the memory accesses in the controller during the P and Q calculations. Typically, the controller's direct memory access (DMA) engine can be programmed by the controller's processor to perform a P or Q calculation. Once the data for the entire stripe is cached, the processor allocates a stripelet buffer for each P and Q calculation. It first fills these buffers with zeroes. It then proceeds to issue a command to the controller's DMA engine to perform a P or Q calculation for each data stripelet in cache. Upon receiving the command, the DMA engine reads a certain number of bytes, or a “line” of data, from the data stripelet in memory. It also reads the corresponding line of data from the allocated P or Q stripelet buffer. It performs the P or Q calculation on the two lines of data and writes the result back to the P or Q stripelet buffer, effectively 3 DMA operations per line. Then the next lines are read, calculated, and written back. This process continues until the calculations are complete for the entire stripelet of data. This process needs to be repeated for every cached data stripelet in the stripe. If the stripe supports multiple P and Q stripelets, the entire procedure needs to be done for each P and Q stripelet. For example, to perform a full stripe write in a 32 disk RAID 6, the processor reads 30 stripelets of data into memory, allocates and zeros out 2 stripelet buffers for the P and Q calculation, issues 30 commands to the DMA engine to perform the P calculations, and then issues 30 commands to the DMA engine to perform the Q calculations. If the stripelet size is 64 kilobytes and the line size is 512 bytes, then the P and Q calculations for the entire stripe require 23,040 DMA operations [(3*(65536/512)*30)*2] or 7680 data reads, 3840 P reads, 3840 P writes, 3840 Q reads and 3840 Q writes.

FIGS. 5A and 5B are diagrams depicting a full stripe write operation in a RAID 6 system (prior art). In Step 1 new data is fetched into memory. In Step 2, parity P and parity Q are zeroed out. In Step 3 the drive 0 parity P is updated. In Step 4 the drive 1 parity P is updated. In Step 5 the drive 2 parity P is updated. In Step 6 the drive 0 parity Q is updated. In Step 7 the drive 1 parity Q is updated. In Step 8 the drive 3 parity Q is updated. In Step 9, new stripes are written to the disks. Only 5 disk writes are required, as opposed to the 9 read/writes that would be required if each stripelet is updated individually. However, the process is memory intensive—2 reads from data are required, as well as multiple read/writes from parity. Further, the process is microprocessor intensive, requiring up to 8 separate memory-to-memory operations.

It would be advantageous if a process existed to speed up the calculation of XOR and Galois products for an entire stripe of data that did not involve the extensive use of memory or microprocessor operations.

### SUMMARY OF THE INVENTION

The present invention introduces a stripe handling process that improves memory access by avoiding the writing of partially calculated data to the P and Q stripelets. Each partial calculation requires a read followed by a write to the P or Q stripelet for every read of a data stripelet. Stripe handling performs calculations for the whole stripe, allowing the P or Q stripelet to be written only once, after all the data stripelets have been read. A reading of the P and Q stripelets is no longer necessary. Since multiple calculations are done in parallel, the data stripelets need to be read only once. Considering the 32 disk RAID 6 example, the same operation using the Stripe Handler requires 3840 data reads, 128 P writes, and 128 Q writes, resulting in a total of 4096 DMA operations of 512 bytes each, versus 23,040 DMA operations for a conventional RAID 6 system. The need to pre-fill the P and Q stripelets in memory with zeroes is also eliminated. Processor overhead is also improved by creating one command versus 60 partial commands.

Accordingly, a method is provided for automating full stripe operations in a redundant data storage array. In a redundant storage device controller a parity product is accumulated that is associated with an information stripe. The parity product is stored in controller memory in a single write operation. A stored parity product can then be written in a storage device. More explicitly, a parity product may be accumulated in a RAID controller, stored in a RAID controller memory, and the stored parity product written in a RAID.

For example, the controller may receive n data stripelets for storage in the RAID. The parity product is accumulated by creating m parity stripelets, and the m parity stripelets are written into the controller memory in a single write operation.

Alternately, the controller may receive (n+m−x) stripelets from a RAID with (n+m) drives. In this aspect, accumulating the parity product includes recovering x stripelets. Then, storing the parity product involves writing x stripelets into controller memory in a single write operation.

Additional details of the above-described method and a system for automating full stripe operations in a redundant data storage array are provided below.

### BRIEF DESCRIPTION OF THE DRAWINGS

FIGS. 1A and 1B are diagrams depicting a RAID 5 system (prior art).

FIGS. 2A and 2B are a depiction of a RAID 6 system (prior art).

FIGS. 3A and 3B are diagrams depicting a sequence of events in a RAID 5 write operation (prior art).

FIGS. 4A and 4B are diagrams depicting a sequence of events in a RAID 6 write operation (prior art).

FIGS. 5A and 5B are diagrams depicting a full stripe write operation in a RAID 6 system (prior art).

FIG. 6 is a schematic block diagram depicting a system for automating full stripe operations in a redundant data storage array.

FIGS. 7A and 7B are diagrams depicting parity product accumulation through the creation of a parity stripelet.

FIG. 8 is a schematic block diagram depicting a variation of the system shown in FIG. 6.

FIG. 9 is a flowchart illustrating a method for automating full stripe operations in a redundant data storage array.

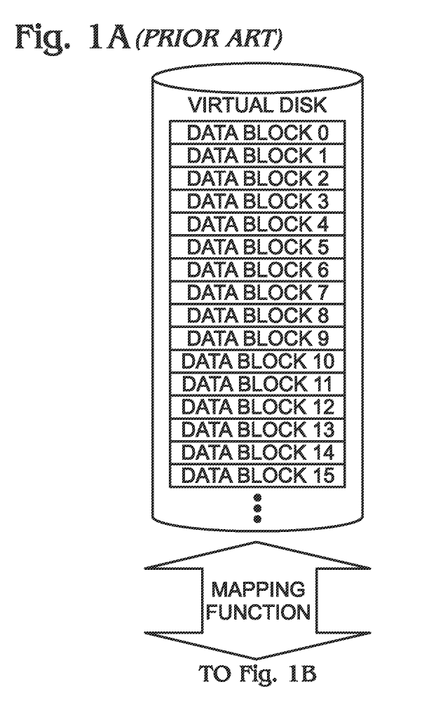

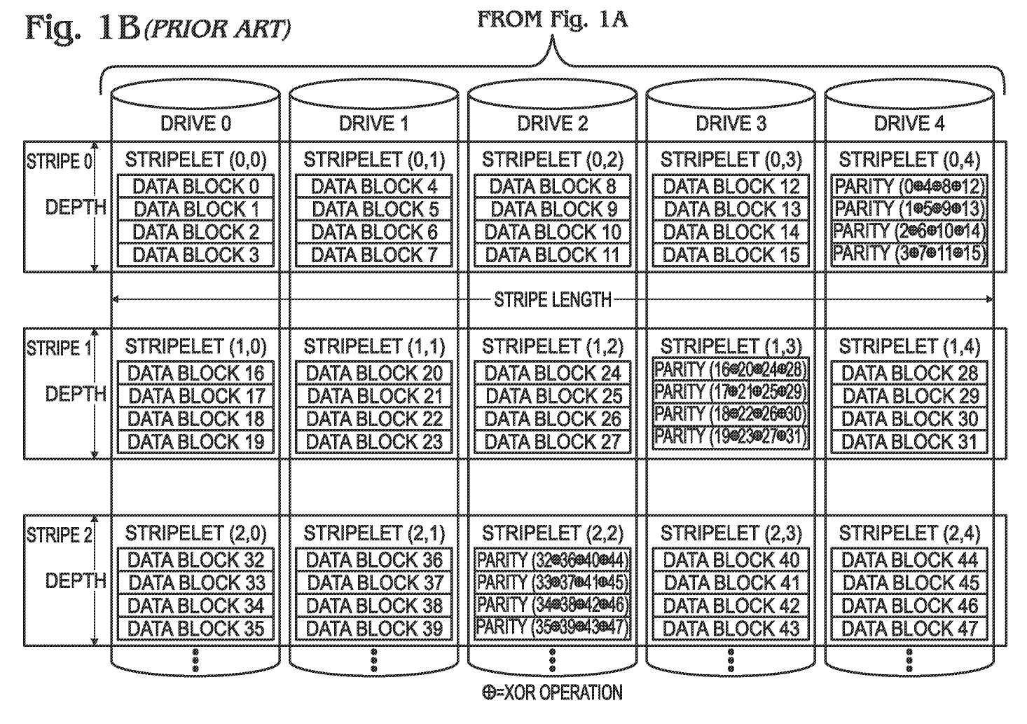

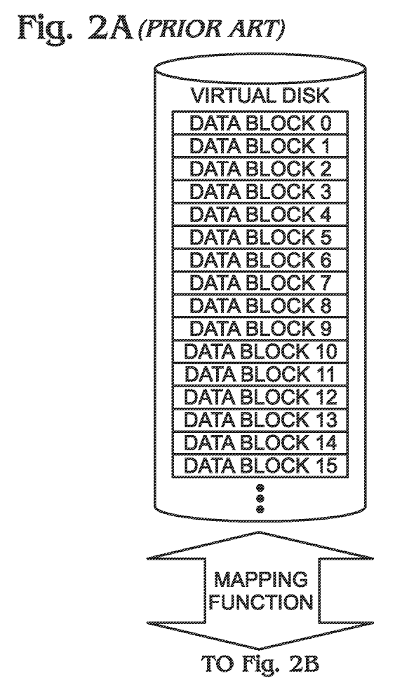

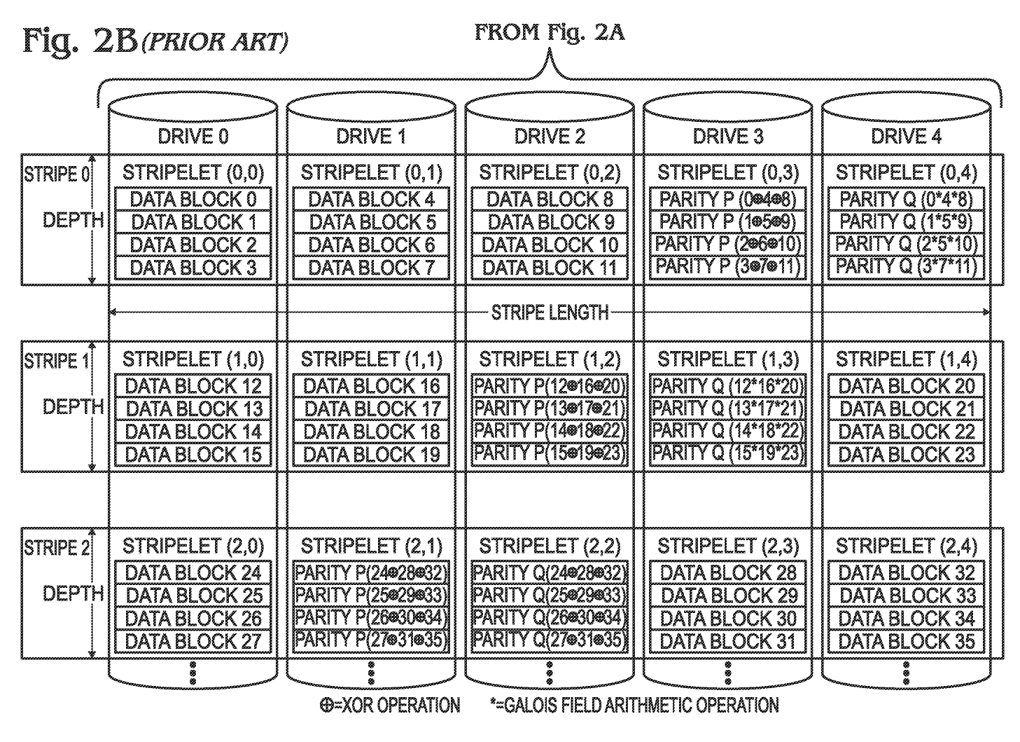

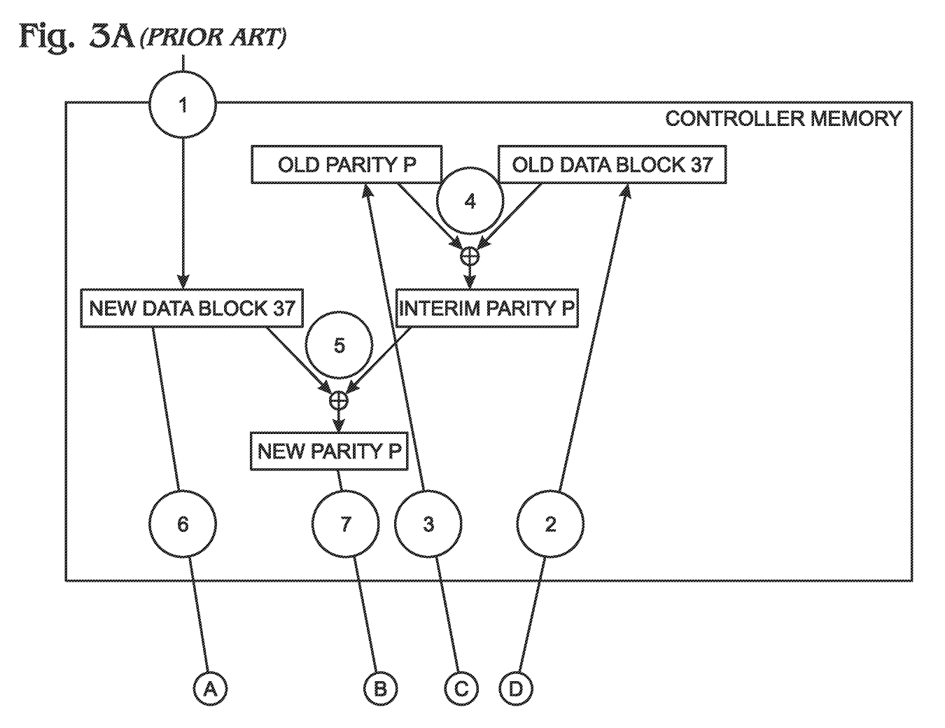

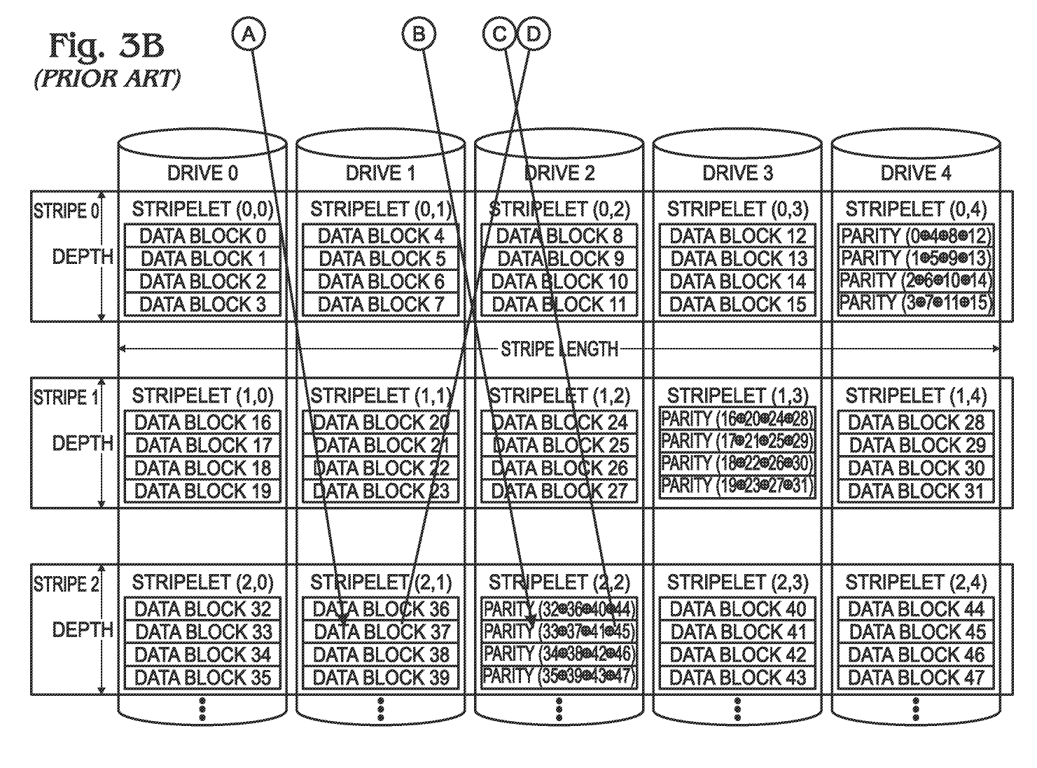

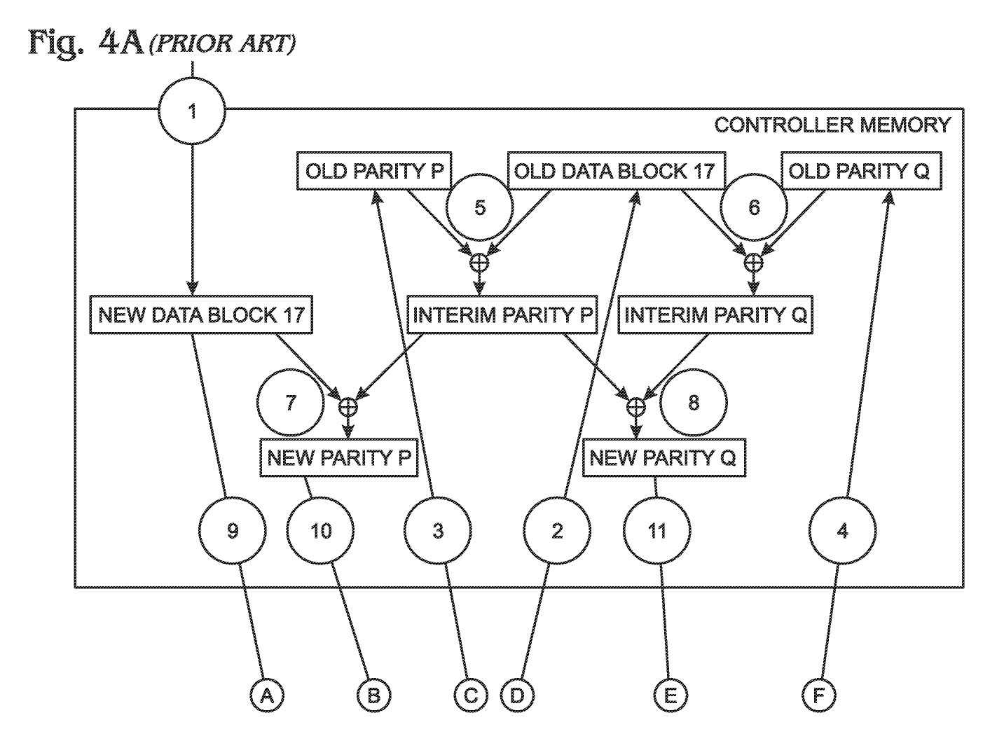

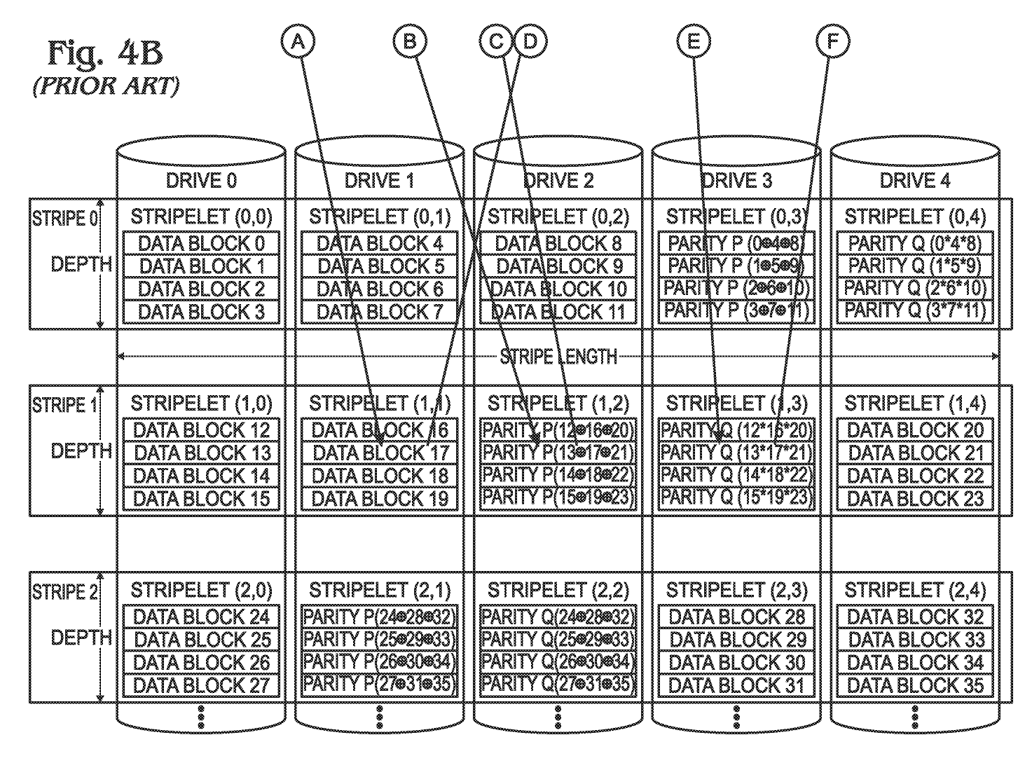

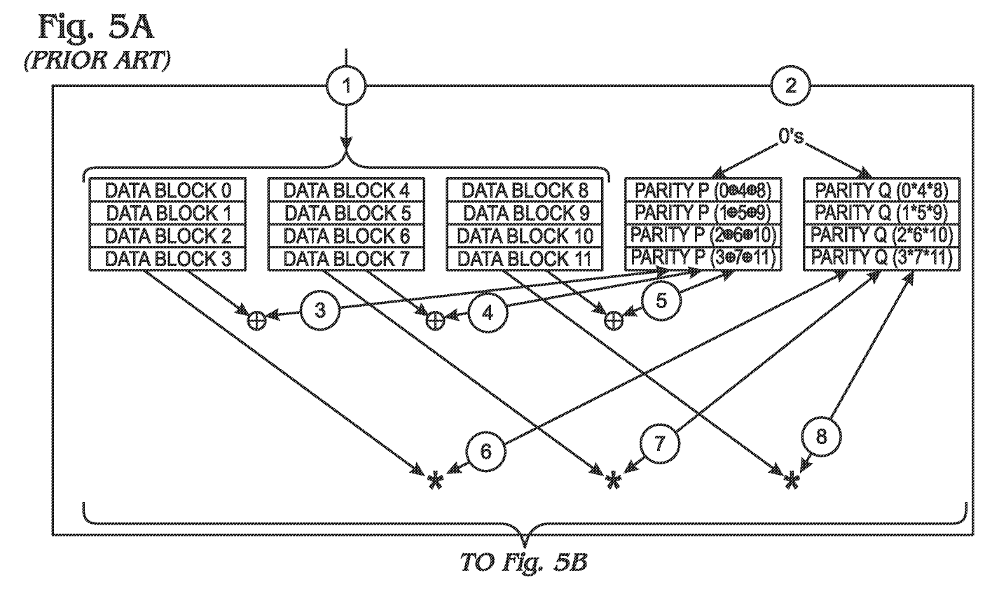

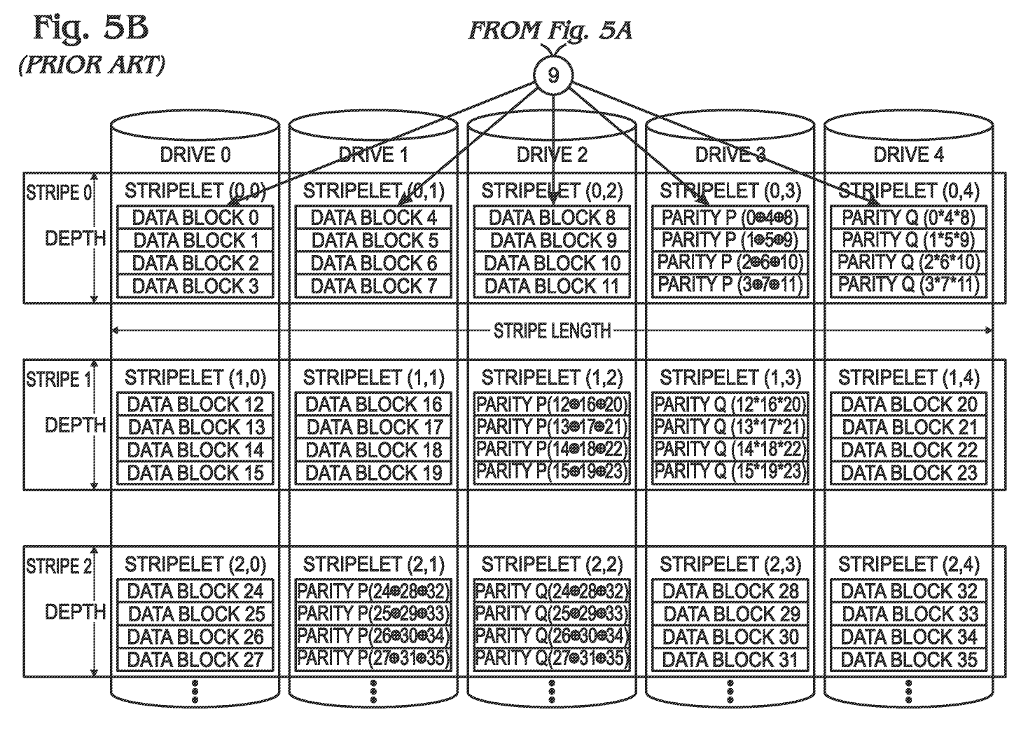

### DETAILED DESCRIPTION

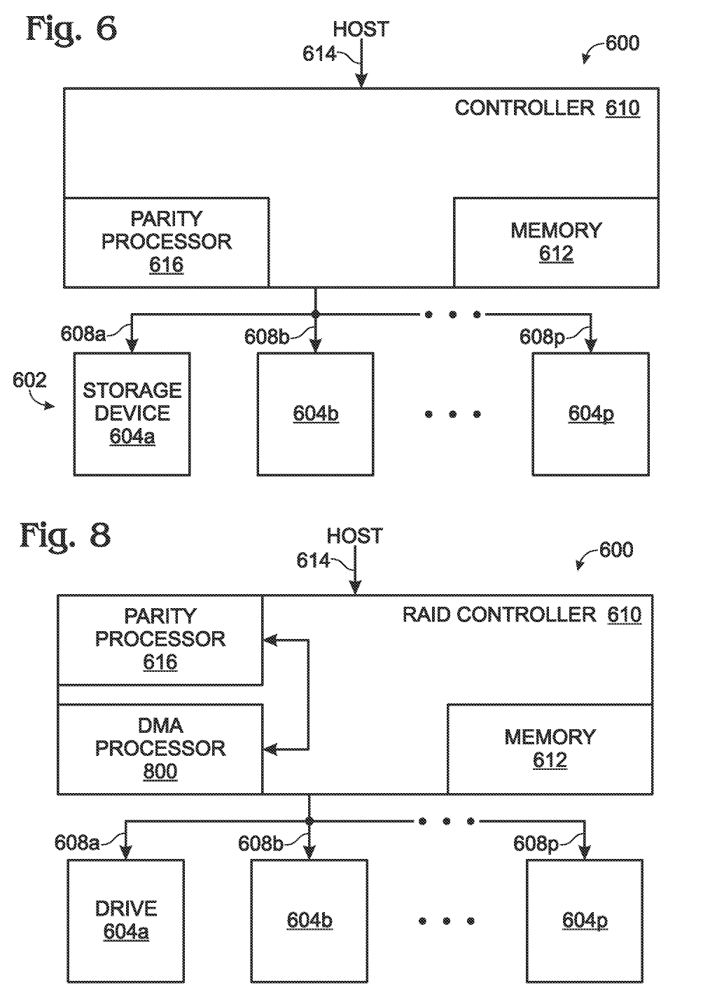

FIG. 6 is a schematic block diagram depicting a system for automating full stripe operations in a redundant data storage array. The system 600 comprises an array 602 of redundant data storage devices 604a though 604p, where p is not limited to any particular value. Each device 604a-604p has a controller interface for reading and writing data on lines 608a through 608p, respectively. A controller 610 is shown with a memory 612 and a storage device interface on line 608. The controller 610 accumulates a parity product associated with an information stripe of data, and stores the parity product in the memory 612 in a single write operation, subsequent to accumulating the parity product. Then, the stored parity product can be written into a storage device 604. In one aspect, the array 602 of redundant data storage devices is a redundant array of disk drives (RAID). Then, the controller 610 is a RAID controller with an embedded controller memory 612 and a RAID interface.

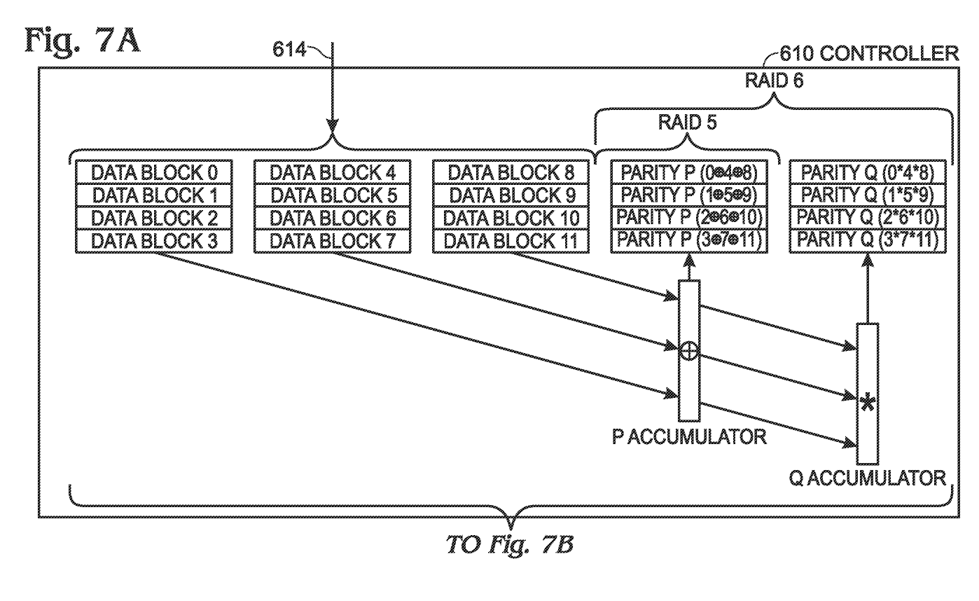

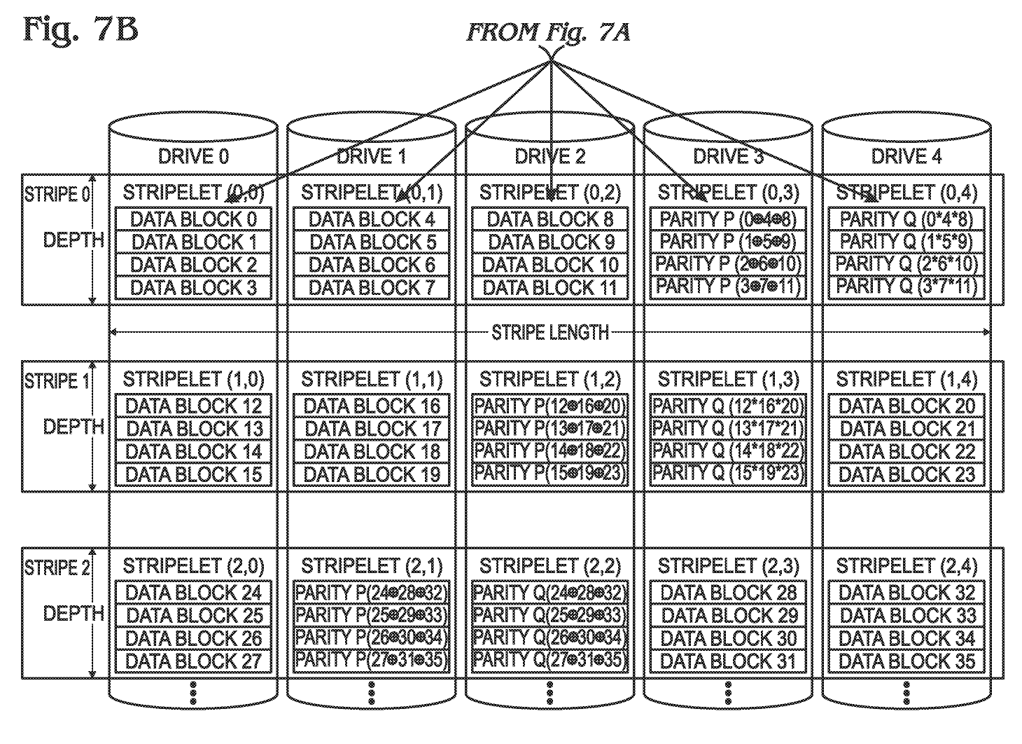

The RAID controller 610 may include a parity processor 616 for accumulating parity products using an exclusive-or (XOR) calculations (e.g., RAID 5), or Galois products, or a combination of Galois products and XOR calculations (e.g., RAID 6). In another aspect, the RAID controller 610 is able to parallely accumulate both P and Q parity information. The controller 610 may accumulate information from a first group of corresponding data blocks, and then accumulate information from a second group of corresponding data blocks in the same stripe. As noted in more detail below, the accumulation of parity information may be accomplished with accumulator hardware (see FIG. 7).

The RAID controller 610 may accumulate a parity product that involves the creation of a parity stripelet or the recovery of a stripelet. In one aspect, the RAID controller 610 includes a host interface on line 614 for receiving n data stripelets for storage in the RAID. The RAID controller 610 creates m parity stripelets and writes the m parity stripelets into the controller memory 612 in a single write operation.

In one aspect the RAID includes (n+m=p) drives. The RAID controller 610 accumulates a parity product by receiving (n+m−x) stripelets from the RAID interface 608, recovers x stripelets, and writes x stripelets into controller memory 612 in a single write operation.

FIGS. 7A and 7B are diagrams depicting parity product accumulation through the creation of a parity stripelet. In this example there are p drives (p=5). The RAID controller 610 may receive n data stripelets for storage in the RAID via the host interface 614. In this example, n=3. Each stripelet includes 4 data blocks. For simplicity, data block 0, data block 4, and data block 8 are referred to herein as the first data block in each data stripelet. The RAID controller 610 accumulates parity for the first data block from the n data stripelets and writes the parity information for the first data block in a single write operation. In a RAID 5 system, a parity P block is created. In a RAID 6 system, both a parity P and a parity Q block are created. The operations involve only 1 read from data and 1 write to parity. Further, only a single microprocessor operation is used to calculate parity.

More explicitly, the RAID controller 610 receives n data stripelets (n=3) for storage in the RAID via the host interface 613, with a first plurality of data blocks in each data stripelet. In this example each stripelet includes 4 data blocks. The RAID controller accumulates parity information for the first group of information blocks (data blocks 0, 4, and 8) from the 3 stripelets, writes the parity information for the first group of data blocks in a single write operation. The controller 610 iteratively creates and writes parity information for groups of information blocks from the first plurality until m parity stripelets are created. In a RAID 5 system, m=1, and in a RAID 6 system, m=2. If multiple parity stripelets are created, the parity information for each parity stripelet is accumulated parallely. After processing the first group of data blocks, a second group of data blocks (data blocks 1, 5, and 9) are processed to create a corresponding parity block (RAID 5) or parity P and parity Q blocks (RAID 6). The process is iteratively repeated until the entire parity stripelet(s) is created.

As another variation however, the RAID controller 610 may receive n data stripelets for storage in the RAID via the host interface, with a first and second data block in each data stripelet (as defined above). The RAID controller 610 initially accumulates and writes a parity product(s) for a first data block in a single write operation, and subsequently accumulates and writes a parity product(s) for the second data block in a single write operation.

FIG. 8 is a schematic block diagram depicting a variation of the system shown in FIG. 6. In this system the RAID controller 610 includes a direct memory access (DMA) processor 800 and a parity processor 616. The parity processor 616 creates the m parity stripelets by controlling the DMA processor 800 to partially accumulate parity information associated with the first data block in the n data stripelets, and releases control over the DMA processor 800, so the DMA processor may perform other functions. The parity processor 616 iteratively accesses the DMA processor until the parity information for all the data blocks in all the n data stripelets are fully accumulated.

At a more detailed level, the parity processor 616 accumulates the parity product for the information strip by performing a parity operation with the first bit of a first stripelet (e.g., the first bit of data block 0, see FIGS. 7A and 7B), creating a partial parity accumulation. Then, the parity processor 800 serially performs a parity operation between the first bit of any remaining stripelets in the strip (e.g., the first bits of data blocks 4 and 8) and the partial parity accumulation, forming the accumulated parity product in response to a final parity operation. Alternately stated, the parity processor 800 completely calculates a parity product for a first bit in the information stripe, prior to storing any first bit parity information in the controller memory.

Although the system depicted in FIGS. 6-8 are explained in the context of hardware devices, aspects of the systems may be enabled as instructions stored in memory executed by a microprocessor or logic-coded state machine.

### FUNCTIONAL DESCRIPTION

The system of FIGS. 6 through 8, which is referred to herein as the Stripe Handler, automates the process of calculating P and Q for an entire stripe. Instead of individual commands, the system provides a single command to process the calculations for the entire stripe. The processor creates a command that consists of a length, a command, a list of source addresses, and a list of destination addresses. The length describes the number of bytes that each stripelet contains. The command specifies which calculations to perform. The Stripe Handler can perform multiple calculations in parallel. The source addresses indicate the location of each data stripelet in controller memory. There is no limit to the number of source addresses that can be used. The destination addresses indicate the location in controller memory where the P and/or Q calculations are to be written.

The command is organized in groups, where each group consists of a finite number of addresses. For each group, the DMA engine is dedicated to the Stripe Handler. After completing a task on a group, the DMA Engine allows other devices within the controller to access memory, before starting work on the next group. The grouping provides predictable memory access behavior in the Stripe Handler regardless of the number of addresses in the overall command. In one implementation the maximum number of addresses per group is 4, but the command can be organized to specify a number of addresses between 1 and 4. Each group can consist of different number of addresses. The last group specifies the destination addresses of the P and Q stripelets.

In operation, the Stripe Handler starts with the first group and reads in a line of data from each source address in the group. It performs the calculations specified in the command and stores the results in internal accumulators. The accumulators are equal in size to that of a line of data. The calculations are done in parallel. The Stripe Handler then proceeds to the next group, reading a line of data from each source address, updating the P and/or Q calculations in the accumulators. It then continues with the remaining groups until a line of data has been read from all the source addresses. At the last group, the Stripe Handler writes the contents of the accumulators to the destination addresses. Since all the calculations are performed before writing to the P and/or Q, zeroing out the destination stripelets is unnecessary. The Stripe Handler then goes back to the first group and reads the next line of data from the source addresses. It then proceeds through all of the groups until a line of data has been read from all source addresses and the resulting calculations have been written to the destination addresses. This process is repeated until the entire length of all the data stripelets have been read and the entire length of the P and Q stripelets have been written.

The Stripe Handler improves memory access by avoiding the writing of partially calculated data to the P and Q stripelets. Each partial calculation requires a read followed by a write to the P or Q stripelet for every read of a data stripelet. The Stripe Handler performs calculations for the whole stripe which permits the P or Q stripelet to be written only after all data stripelets have been read. Reading of the P and Q stripelets is no longer necessary. And, since multiple calculations are done in parallel, the data stripelets need to be read only once. The need to pre-fill the P and Q stripelets in memory with zeroes is also eliminated. Processor overhead is also improved by creating a single command.

Memory access is also more efficient by grouping the reads and writes together, instead of interleaving writes with reads during partial calculation updates. The grouping of data stripelet reads provides predictable memory bandwidth utilization and allows the Stripe Handler to support any number of disks within a stripe without creating adverse side effects for other resources requiring memory bandwidth. The ability to format the command in such a way that reduces the number of addresses per group allows for tuning the memory utilization of the Stripe Handler.

Although, the above description has focused on full-stripe writes, the Stripe Handler can also be used when full-stripe reads are necessary to reconstruct data due to a failure of a disk.

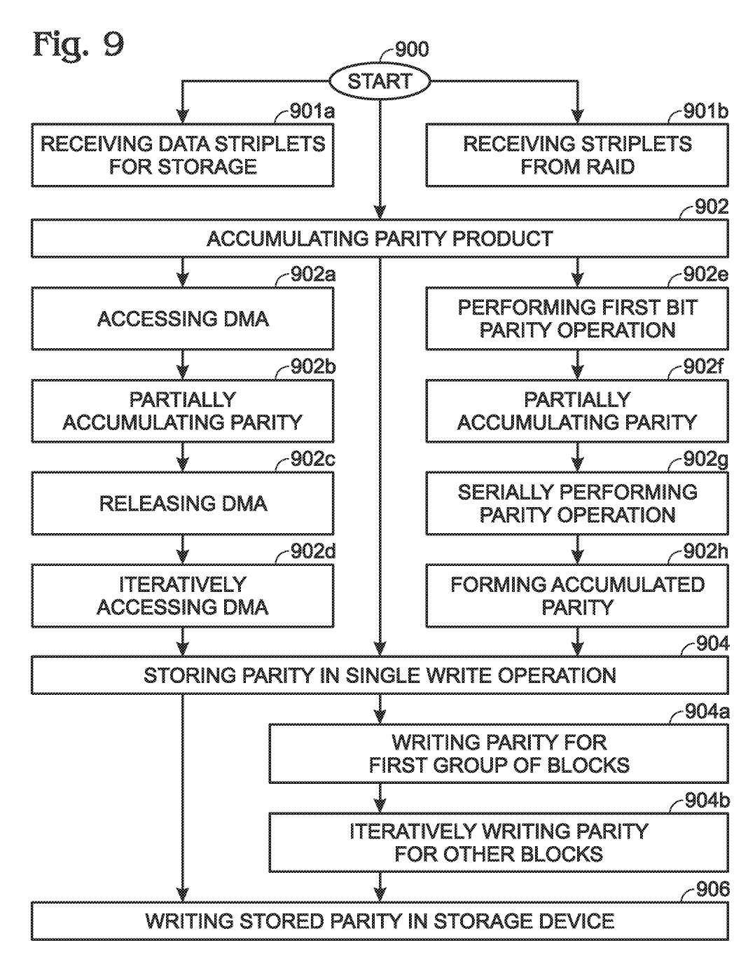

FIG. 9 is a flowchart illustrating a method for automating full stripe operations in a redundant data storage array. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 900.

Step 902 accumulates a parity product associated with an information stripe in a redundant storage device controller. The accumulating of parity product involves either creating a parity stripelet or recovering a stripelet. Typically, Step 902 parallely accumulates P and Q parity information, e.g., for a RAID 6 system. The accumulation of the parity products may use an operation such as XOR calculations, Galois products, or combination of Galois products and XOR calculations. In a single write operation, Step 904 stores the parity product in a controller memory. Step 906 writes the stored parity product in a (one or more) storage device(s).

In one aspect, accumulating the parity product in Step 902 includes accumulating the parity product in a RAID controller. Then, storing the parity product (Step 904) includes storing the parity product in a RAID controller memory. Writing the stored parity product in Step 906 includes writing the stored parity product in a RAID.

For example, Step 901a receives n data-stripelets for storage in the RAID at the controller. Then, accumulating the parity product in Step 902 includes creating m parity stripelets, and storing the parity product (Step 904) includes writing the m parity stripelets into the controller memory in a single write operation.

In one aspect, receiving n data stripelets for storage (Step 901a) includes receiving a first data block in each data stripelet, and Step 902 creates m parity stripelets by accumulating parity for the first data block from the n data stripelets. Then, writing the m parity stripelets into the controller memory (Step 904) includes writing the parity information for the first data block in a single write operation.

In another aspect, receiving n data stripelets for storage in Step 901a includes receiving a first plurality of data blocks in each data stripelet. Step 902 creates m parity stripelets by accumulating parity information for a first group of data blocks from the first plurality. Then, writing the m parity stripelets into the controller memory (Step 904) includes substeps. Step 904a writes the parity information for the first group of data blocks in a single write operation. Step 904b iteratively creates and writes parity information for groups of information blocks from the first plurality until the m parity stripelets are created.

In another variation, creating m parity stripelets in Step 902 includes substeps. Step 902a accesses a DMA processor. Step 902b controls the DMA processor to partially accumulate parity information associated with the first data block in the n data stripelets. Step 902c releases control over the DMA processor. Step 902d iteratively accesses the DMA processor until the parity information for the first data block in all the n data stripelets is fully accumulated.

In a different aspect, Step 901b receives (n+m−x) stripelets from a RAID with (n+m) drives at the controller, and accumulating the parity product in Step 902 includes recovering x stripelets. Then, storing the parity product in Step 904 includes writing x stripelets into controller memory in a single write operation.

In one aspect, accumulating parity product for the information strip (Step 902) includes a different set of substeps. Step 902e performs a parity operation with the first bit of a first stripelet. Step 902f creates a partial parity accumulation. Step 902g serially performs a parity operation between the first bit of any remaining stripelets in the strip, and the partial parity accumulation. Step 902h forms the accumulated parity product in response to a final parity operation.

Alternately stated, accumulating the parity product for the information strip (Step 902) includes completely calculating a parity product for a first bit in the information strip. Then, storing the parity product in a single write operation (Step 904) includes storing only the completely calculated parity product for the first bit.

A system and method have been presented for automating full stripe operations in a redundant data storage array. RAID 5 and RAID 6 structures have been used as examples to illustrate the invention. However, the invention is not limited to merely these examples. Other variations and embodiments of the invention will occur to those skilled in the art.

We claim:

1-22. (canceled)

23. In a parity microprocessor, a method for automating full stripe operations for a redundant data storage array, the method comprising:
a parity processor issuing a command to perform a parity operation;
in response to the command, a Stripe Handler processor module accumulating a parity product for an entire information stripe stored in local memory; and,
upon accumulation of the parity product, the Stripe Handler processor module storing the parity product in the local memory in a single write operation.

24. The method of claim 23 wherein issuing the command to perform the parity operation includes issuing a single command specifying stripelet lengths and groups, the groups including parity calculations to perform, source addresses in local memory for the information stripe, and destination addresses in local memory for the accumulated parity.

25. The method of claim 24 wherein issuing the command specifying the parity calculation to perform includes specifying a calculation selected from a group consisting of creating a parity stripelet and recovering a stripelet.

26. The method of claim 23 wherein accumulating the parity product for the entire information stripe includes parallely accumulating P and Q parity information.

27. The method of claim 23 wherein accumulating parity products for the entire information stripe includes accumulating information using an operation selected from a group consisting of exclusive-or (XOR) calculations, Galois products, and a combination of Galois products and XOR calculations.

28. The method of claim 23 wherein accumulating the parity product for an entire information stripe includes:
reading n data stripelets from sources addresses in the local memory;
creating m parity stripelets from the is data stripelets; and,
wherein storing the parity product in the local memory includes writing the m parity stripelets into destination addresses in the local memory in a single write operation.

29. The method of claim 28 wherein reading n data stripelets from sources addresses in the local memory includes reading a first data block in each data stripelet;
wherein creating m parity stripelets from the n data stripelets includes accumulating parity for the first data block from the n data stripelets; and,
wherein storing the parity product in the local memory includes writing the parity information for the first data block into the local memory in a single write operation.

30. The method of claim 29 wherein creating m parity stripelets includes:
accessing a direct memory access (DMA) processor;
controlling the DMA processor to partially accumulate parity information associated with the first data block in the n data stripelets;
releasing control over the DMA processor; and,
iteratively accessing the DMA processor until the parity information for the first data block in all the n data stripelets is fully accumulated.

31. The method of claim 23 wherein accumulating the parity product for an entire information stripe includes:
reading (n+m−x) stripelets from sources addresses in the local memory, associated with a RAID having (n+m) drives;
reassembling x stripelets by XOR'ing the (n+m−x) stripelets; and,
wherein storing the parity product in the local memory includes writing the x reassembled stripelets into destination addresses in the local memory.

32. The method of claim 23 further comprising:
the parity processor writing the locally stored parity product into a redundant array of disk drives (RAID).

33. A microprocessor system for automating full stripe operations in a redundant data storage array, the system comprising:
a local memory;
a parity processor including:
an accumulator; and,
a Stripe Handler module having an interface to accept a command to perform a parity operation, the Stripe Handler module reading an information stripe from the local memory, accumulating parity calculations for the information stripe in the accumulator, and writing a final parity product from the accumulator into the local memory in a single write operation.

34. The system of claim 33 wherein the parity processor issues a single command to the Stripe Handler module specifying stripelet lengths and groups, the groups including parity calculations to perform, source addresses in local memory for the information stripe, and destination addresses in local memory for the accumulated parity.

35. The system of claim 34 wherein the parity processor specifies a parity calculation selected from a group consisting of creating a parity stripelet and recovering a stripelet.

36. The system of claim 33 wherein the accumulator includes a P accumulator and an Q accumulator; and,
wherein the Stripe Handler module parallely performs P and Q parity calculators and accumulates the respective results in the P and Q accumulators.

37. The system of claim 33 wherein the Stripe Handler module performs parity calculations selected from a group consisting of exclusive-or (XOR) calculations, Galois products, and a combination of Galois products and XOR calculations.

38. The system of claim 33 wherein the accumulator includes m parallel accumulators;
wherein the Stripe Handler module reads n data stripelets from sources addresses in the local memory, performs calculations on the n data stripelets, accumulates m parity stripelets in the m accumulators, and writes the m parity stripelets into destination addresses in the local memory in a single write operation.

39. The system of claim 38 wherein the Stripe Handler reads a first data block in each data stripelet from the local memory, accumulates parity for the first data block from the n data stripelets in the m accumulators, and writes the parity information for the first data block from the m accumulators into the local memory in a single write operation.

40. The system of claim 39 further comprising:
a direct memory access (DMA) processor;
wherein the Stripe Handler module controls the DMA processor to partially accumulate parity information associated with the first data block in the n data stripelets, releases control over the DMA processor, and iteratively accesses the DMA processor until the parity information for the first data block in all the n data stripelets is fully accumulated.

41. The system of claim 33 wherein the accumulator includes x parallel accumulators;
wherein the Stripe Handler reads (n+m−x) stripelets from sources addresses in the local memory associated with a RAID having (n+m) drives, reassembles x stripelets in the x accumulators by XOR'ing the (n+m−x) stripelets, and writes the x reassembled stripelets into destination addresses in the local memory.

42. The system of claim 33 wherein the parity processor writes the parity product stored in the local memory to a redundant array of disk drives (RAID).
